(19) United States
(12) Patent Application Publication
(10) Pub. No.: US 2014/0316691 A1
(43) Pub. Date: Oct. 23, 2014

(54) METHOD AND TERMINAL FOR PROVIDING ELECTRONIC MAP

(71) Applicant: Xiaomi Inc., Beijing (CN)

(72) Inventors: Yuan REN, Beijing (CN); Peiling Yao, Beijing (CN); Darui Xu, Beijing (CN)

(73) Assignee: Xiaomi Inc., Beijing (CN)

(21) Appl. No.: 14/183,094

(22) Filed: Feb. 18, 2014

Related U.S. Application Data
(63) Continuation of application No. PCT/CN2013/085860, filed on Oct. 24, 2013.

(30) Foreign Application Priority Data
Apr. 23, 2013 (CN) 201310143793.8

(51) Int. Cl. G01C 21/00

(52) U.S. Cl. CPC G01C 21/00
USPC 701/409

(57) ABSTRACT

A method for a device to provide an electronic map includes receiving user input to start an electronic map; obtaining, responsive to the receiving, electronic map filtrating information; and determining, from a plurality of electronic maps, an electronic map matching the electronic map filtrating information.

### CROSS-REFERENCE TO RELATED APPLICATIONS

This application is a continuation of International Application No. PCT/CN2013/085860, filed Oct. 24, 2013, which is based upon and claims priority to Chinese Patent Application No. 201310143793.8, filed Apr. 23, 2013, the entire contents of both of which are hereby incorporated by reference.

### TECHNICAL FIELD

The present disclosure generally relates to the field of information processing and, more particularly, to a method and a device for providing an electronic map.

### BACKGROUND

Electronic maps may be used not only to search for various locations, but also to inquire about travel routes. For example, when a user travels from a position A to a position B, the user can check an electronic map regarding how to take buses and how to make transfers, or which route should be selected for car driving. In addition, electronic maps may also be used for accessing and providing information. For example, when the user finds a restaurant on an electronic map, besides geographic location of the restaurant, the user can also find other information regarding the restaurant, such as contact information and service information.

Conventionally, different electronic maps may have different functions. For example, Table 1 below summarizes different functions provided by conventional electronic maps A though G from different map providers, respectively. In Table 1, “√” represents that the electronic map has the corresponding function, and “—” represents that the electronic map does not have the corresponding function.

TABLE 1

| Function | Map A | Map B | Map C | Map D | Map E | Map F | Map G | Notes |
|---|---|---|---|---|---|---|---|---|
| Mark | ✓ | ✓ | ✓ | ✓ | — | ✓ | ✓ | For |
| Interface | | | | | | | | customizing |
| | | | | | | | | location and |
| | | | | | | | | content on map |
| Search | ✓ | ✓ | ✓ | ✓ | ✓ | ✓ | ✓ | Including |
| Function | | | | | | | (Charged) | peripheral |
| | | | | | | | | inquiring |
| Navigation | ✓ | ✓ | ✓ | ✓ | ✓ | ✓ | ✓ | For self-drive |
| Function | | | (Charged) | (Main | | (Highways | (Charged) | route inquiring |
| | | | | road) | | Only) | | |
| Bus Inquiry | ✓ | ✓ | ✓ | ✓ | ✓ | — | ✓ | Including bus |
| Function | | | (Charged) | | | | (Charged) | transfer and bus |
| | | | | | | | | route |
| GPS | ✓ | ✓ | — | ✓ | — | — | — | Analyzing and |
| coordinate | (Charged) | | | | | | | displaying |
| mark | | | | | | | | coordinate on |
| | | | | | | | | map with GPS |
| | | | | | | | | ID |
| Traffic | — | ✓ | ✓ | ✓ | — | — | — | Real time |
| Condition | | | (Charged) | | | | | traffic |
| | | | | | | | | condition, |
| | | | | | | | | using colors of |
| | | | | | | | | traffic lights to |
| | | | | | | | | represent traffic |
| | | | | | | | | situations |
| Address | ✓ | ✓ | ✓ | ✓ | ✓ | ✓ | ✓ | Transformation |
| Resolution | | (Limited | | (Limited | (Charged) | (Limited | (Charged) | between |
| and Reverse | | number | | number of | | number of | | address |
| Address | | of times) | | times) | | times) | | information and |
| Resolution | | | | | | | | longitude and |
| | | | | | | | | latitude |
| | | | | | | | | coordinate |
| | | | | | | | | information |
| Locating | ✓ | ✓ | ✓ | ✓ | ✓ | ✓ | ✓ | Determining |
| Function | | | | | | | (Charged) | user location |
| | | | | | | | | based on IP |
| Satellite | — | — | — | ✓ | — | ✓ | — | Providing |
| Pictures | | | | | | | | satellite |
| Function | | | | | | | | pictures |
| Flash Map | ✓ | ✓ | ✓ | ✓ | ✓ | ✓ | ✓ | |

As shown in Table 1, different electronic maps may have different functions. In addition, electronic maps may have their respective functions limited by regions. For example, the electronic map D provides different functions in a particular region than in other regions.

### SUMMARY

According to a first aspect of the present disclosure, there is provided a method for a device to provide an electronic map, comprising: receiving user input to start an electronic map; obtaining, responsive to the receiving, electronic map filtrating information; and determining, from a plurality of electronic maps, an electronic map matching the electronic map filtrating information.

According to a second aspect of the present disclosure, there is provided a device for providing an electronic map, comprising: a processor; and a memory for storing instructions executable by the processor; wherein the processor is configured to: receive user input to start an electronic map; obtain, responsive to the receiving, electronic map filtrating information; and determine, from a plurality of electronic maps, an electronic map matching the electronic map filtrating information.

According to a third aspect of the present disclosure, there is provided a non-transitory computer-readable medium having stored therein instructions that, when executed by a processor of a device, cause the device to perform a method for providing an electronic map, comprising: receiving user input to start an electronic map; obtaining, responsive to the receiving, electronic map filtrating information; and determining, from a plurality of electronic maps, an electronic map matching the electronic map filtrating information.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart of a method for a device to provide an electronic map, according to an exemplary embodiment.

FIG. 2 is a flowchart of a method for a device to provide an electronic map, according to an exemplary embodiment.

FIG. 3 is a flowchart of a method for a device to provide an electronic map, according to an exemplary embodiment.

FIG. 4 is a block diagram of a device for providing an electronic map, according to an exemplary embodiment.

FIG. 5 is a block diagram of a device for providing an electronic map, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

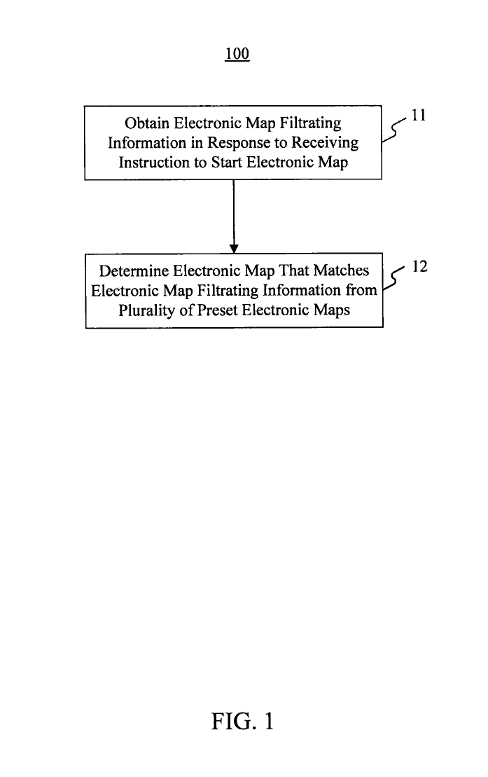

FIG. 1 is a flowchart of a method 100 for a device to provide an electronic map, according to an exemplary embodiment. Referring to FIG. 1, the method 100 includes the following steps.

In step 11, the device obtains electronic map filtrating information in response to receiving an instruction to start an electronic map input by a user. For example, the electronic map filtrating information may be geographic location information input by the user, or current geographic location information of the device obtained by the device.

In exemplary embodiments, the device obtains the current geographic location information by one or more of the following ways: obtaining the current geographic location information based on an IP address; or obtaining the current geographic location information based on global positioning system (GPS) positioning; or obtaining the current geographic location information based on general packet radio service (GPRS) positioning; or obtaining the current geographic location information through a geographic location application program interface embedded in a browser installed on the device.

In step 12, the device determines an electronic map that matches the obtained electronic map filtrating information from a plurality of preset electronic maps. For example, when the electronic map filtrating information is the current geographic location information of the device, the device determines, according to a preset corresponding relationship between geographic location information and the electronic maps, an electronic map corresponding to the current geographic location information from the plurality of preset electronic maps. Also for example, the plurality of preset electronic maps may be remotely stored on a server or locally stored on the device.

In one exemplary embodiment, the device determines one electronic map matching the obtained electronic map filtrating information, and directly loads and displays the determined electronic map, In one exemplary embodiment, the device determines multiple electronic maps matching the obtained electronic map filtrating information. Accordingly, the device displays marks, e.g., icons, of the determined electronic maps, respectively, and loads and displays one of the electronic maps according to the user's selection.

In exemplary embodiments, the device determines whether the obtained current geographic location information is identical to pre-stored geographic location information. For example, the pre-stored geographic location information may be geographic location information obtained a last time when the electronic map function was used. If the device determines that the current geographic location information is identical to the pre-stored geographic location information, the device determines an electronic map that was previously determined according to the pre-stored geographic location information, as the electronic map matching the current geographic location information, so that the electronic map used the last time may be continually used. Since the electronic map used the last time is generally stored in cache while other electronic maps may need to be obtained via a network, direct use of the electronic map used the last time not only reduces calculating operations for the determining of the electronic map, but also reduces the time for loading the electronic map.

Accordingly, in the method 100, an electronic map which matches the electronic map filtrating information is automatically determined and flexibly requested when the user has a need for map service.

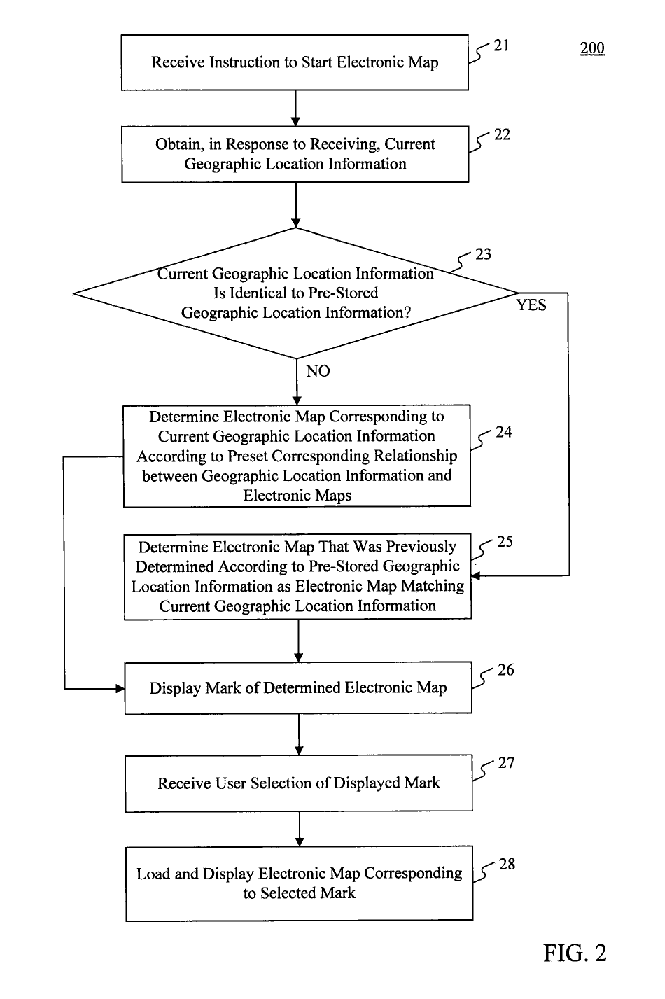

FIG. 2 is a flowchart of a method 200 for a device to provide an electronic map. according to an exemplary embodiment. Referring to FIG. 2, the method 200 includes the following steps.

In step 21, the device receives an instruction to start an electronic map input by a user.

In step 22, the device obtains, in response to the receiving, current geographic location information of the device according to one or more of the following preset ways: obtaining the current geographic location information based on an IP address of the device; obtaining the current geographic location information based on GPS positioning; obtaining the current geographic location information based on GPRS positioning; or obtaining the current geographic location information through a geographic location application program interface embedded in a browser installed on the device.

In step 23, the device determines whether the obtained current geographic location information is identical to pre-stored geographic location information and, if not, performs step 24; otherwise, the device performs step 25.

In step 24, the device determines an electronic map corresponding to the obtained current geographic location information from a plurality of preset electronic maps, according to a preset corresponding relationship between geographic location information and the plurality of preset electronic maps.

In step 25, the device determines an electronic map that was previously determined according to the pre-stored geographic location information as the electronic map matching the obtained current geographic location information.

In step 26, the device displays a mark, e.g., an icon, of the determined electronic map.

In step 27, the device receives a user selection of the displayed mark.

In step 28, the device loads and displays an electronic map corresponding to the selected mark.

In the method 200, there are optional electronic maps available for the device's determination. Not only the suitable electronic map may be determined according to address and location information with flexibility, but also more than one determined electronic map can be provided for the user's selection.

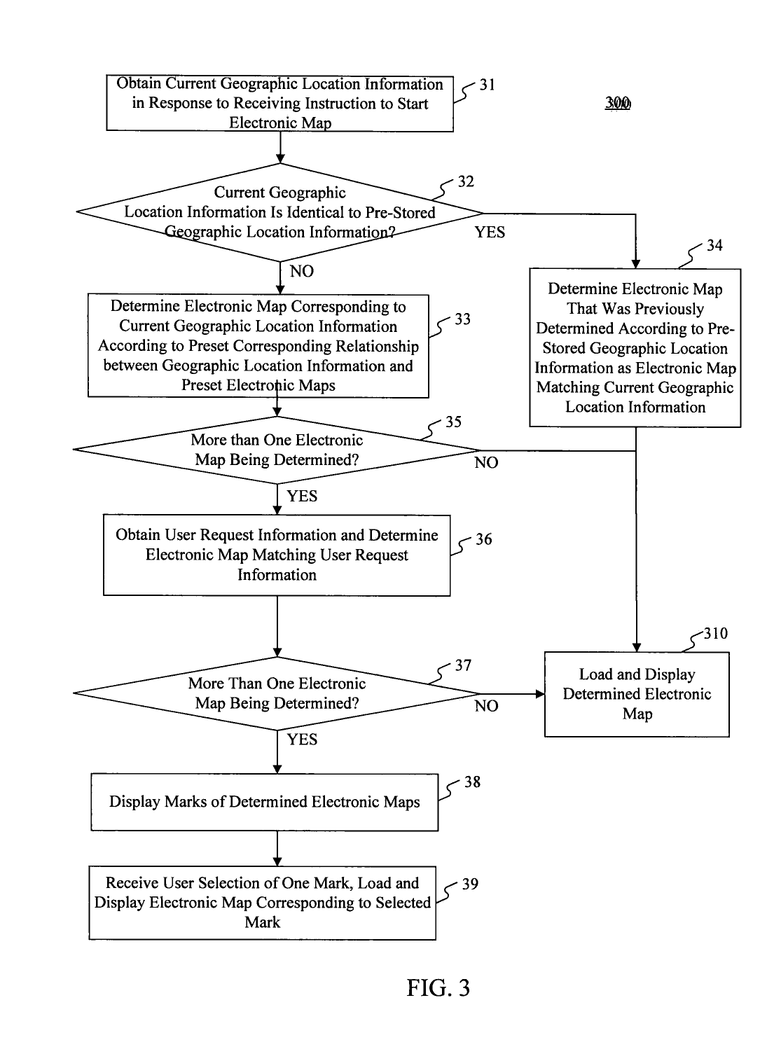

FIG. 3 is a flowchart of a method 300 for a device to provide an electronic map, according to an exemplary embodiment. Referring to FIG. 3, the method 300 includes the following steps.

In step 31, the device obtains current geographic location information in response to receiving an instruction to start an electronic map input by a user.

In step 32, the device determines whether the obtained current geographic location information is identical to pre-stored geographic location information and, if not, performs step 33; otherwise, the device performs step 34.

In step 33, the device determines an electronic map corresponding to the obtained current geographic location information from a plurality of preset electronic maps, according to a preset corresponding relationship between geographic location information and the plurality of preset electronic maps, and then performs step 35.

In step 34, the device determines an electronic map that was previously determined according to the pre-stored geographic location information as an electronic map matching the obtained current geographic location information, and performs step 310.

In step 35, the device determines whether there are more than one electronic map being determined and, if so, performs step 36; otherwise, the device performs step 310.

In step 36, the device obtains user request information, and determines an electronic map matching the user request information. For example, the device determines an electronic map function according to the user request information, and further determines an electronic map having the determined function from the previously determined electronic maps according to respective functions of those electronic maps. Also for example, the user request information may be an inquiry about a self-drive route, an inquiry about a bus route, an inquiry about traffic conditions, an inquiry about GPS coordinates, an inquiry about a satellite picture, etc.

In exemplary embodiments, the device determines in step 33 the electronic maps A through G shown in Table 1 corresponding to the current geographic location information. Accordingly, if the user request information is an inquiry about a self-drive route, the device determines the electronic map function to be a navigation function and, thus, determines the electronic map with the navigation function, i.e., Maps A through G, as the electronic maps matching the user request information.

If the user request information is an inquiry about a bus route, the device determines the electronic map function to be a bus inquiring function and, thus, determines the electronic map with the bus inquiring function, i.e., Maps A, B, C, D, E, and G, as the electronic maps matching the user request information.

If the user request information is an inquiry about traffic condition, the device determines the electronic map function to be a traffic condition function and, thus, determines the electronic map with the traffic condition function, i.e., Maps B, C, and D, as the electronic maps matching the user request information.

If the user request information is an inquiry about GPS coordinates, the device determines the electronic map function to be a GPS coordinate mark function and, thus, determines the electronic map with the GPS coordinate mark function, i.e., Map A, as the electronic map matching the user request information.

If the user request information is an inquiry about a satellite picture, the device determines the electronic map function to be a satellite picture function and, thus, determines the electronic map with the satellite picture function, i.e., Maps D and F, as the electronic maps matching the user request information.

In exemplary embodiments, the device determines multiple electronic map functions according to the user request information. Accordingly, the device further determines an electronic map having the multiple functions from the previously determined electronic maps. For example, if the user request information includes an inquiry about traffic condition and an inquiry about a satellite picture, the device determines Map D as the electronic map matching the user request information.

In step 37, the device determines whether there are more than one electronic map being determined and, if so, performs step 38; otherwise, the device performs step 310.

In step 38, the device displays marks, e.g., icons, of the determined electronic maps, respectively.

In step 39, the device receives a user selection of one of the marks, loads, and displays an electronic map corresponding to the selected mark.

In step 310, the device loads and displays the determined electronic map.

In the method 300, there are optional electronic maps available for the device's determination. Not only the suitable electronic map may be determined with flexibility according to address and location information and the user request information, but also the determined electronic maps may be provided to the user for selection and an optimal electronic map may be loaded based on the user selection.

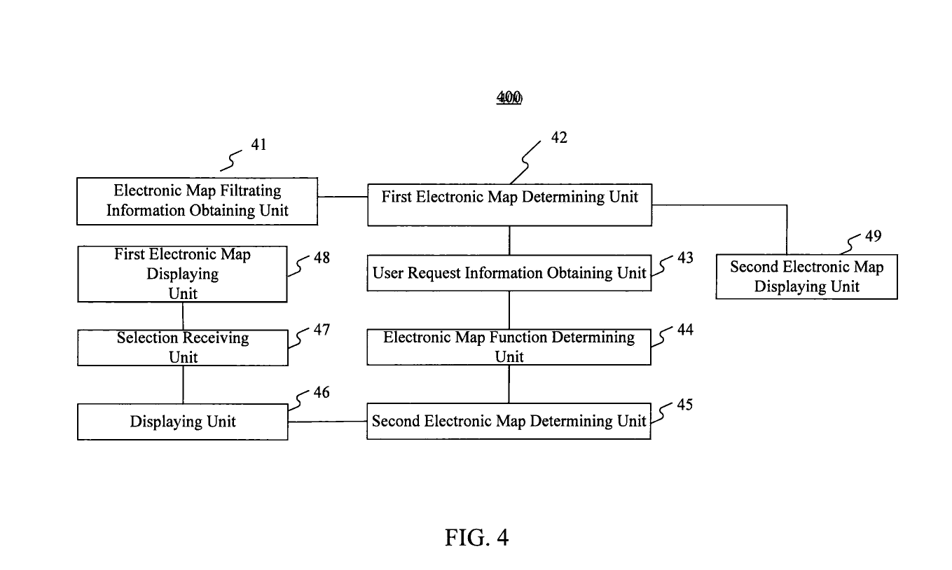

FIG. 4 is a block diagram of a device 400 for providing an electronic map, according to an exemplary embodiment. Referring to FIG. 4, the device 400 includes an electronic map filtrating information obtaining unit 41 and a first electronic map determining unit 42.

In exemplary embodiment, the electronic map filtrating information obtaining unit 41 is configured to obtain electronic map filtrating information in response to receiving a user instruction to start an electronic map. The first electronic map determining unit 42 is configured to determine an electronic map matching the obtained electronic map filtrating information from a plurality of preset electronic maps.

In exemplary embodiments, the device 400 further includes a user request information obtaining unit 43 configured to obtain user request information; an electronic map function determining unit 44 configured to determine an electronic map function corresponding to the user request information; and a second electronic map determining unit 45 configured to determine an electronic map matching the user request information from a plurality of determined electronic maps.

In exemplary embodiments, the device 400 further includes a displaying unit 46 configured to display a mark of an electronic map determined by the first electronic map determining unit 42; a selection receiving unit 47 configured to receive a user selection of the displayed mark; a first electronic map displaying unit 48 configured to load and display an electronic map corresponding to the selected mark, and a second electronic map displaying unit 49 configured to load and display the electronic map determined by the first electronic map determining unit 42.

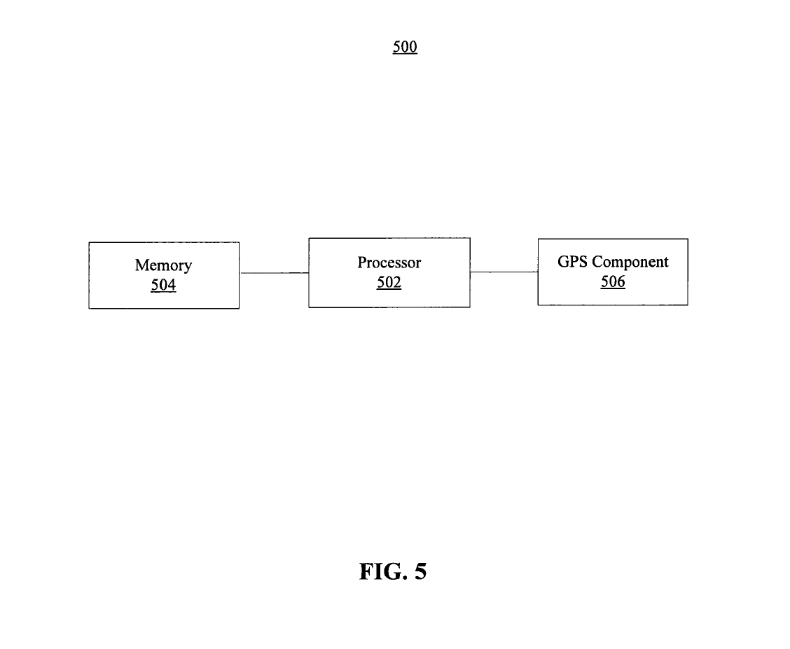

FIG. 5 illustrates a block diagram of a device 500 for providing an electronic map, according to an exemplary embodiment. Referring to FIG. 5, the device 500 includes a processor 502 configured to execute program instructions to perform the above described methods for providing an electronic map, a memory 504 configured to store information and program instructions and otherwise facilitate operation of the processor 502, and a GPS component 506 configured to obtain current geophysical location information of the device 500.

In exemplary embodiments, there is also provided a non-transitory computer-readable medium including instructions, such as included in the memory 504, executable by the processor 502 in the device 500, for performing the above described methods for providing an electronic map.

One of ordinary skill in the art will understand that the above described units can each be implemented by hardware, or software, or a combination of hardware and software. One of ordinary skill in the art will also understand that multiple ones of the above described units may be combined as one unit, and each of the above described units may be further divided into a plurality of sub-units.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for a device to provide an electronic map, comprising:
receiving user input to start an electronic map;
obtaining, responsive to the receiving, electronic map filtrating information; and
determining, from a plurality of electronic maps, an electronic map matching the electronic map filtrating information.

2. The method according to claim 1, wherein the electronic map filtrating information is current geographic location information of the device, the determining comprising:
determining whether the current geographic location information is identical to pre-stored geographic location information;
if it is determined that the current geographic location information is different from the pre-stored geographic location information, determining an electronic map corresponding to the current geographic location information, according to a preset corresponding relationship between geographic location information and the plurality of electronic maps; and
if it is determined that the current geographic location information is identical to the pre-stored geographic location information, determining an electronic map that was previously determined with respect to the pre-stored geographic location information as the electronic map matching the current geographic location information.

3. The method according to claim 1, wherein the obtaining comprises at least one of:
obtaining geographic location information of the device based on an IP address;
obtaining the geographic location information based on global positioning system (GPS) positioning;
obtaining the geographic location information based on general packet radio service (GPRS) positioning; or
obtaining the geographic location information through a geographic location application program interface embedded in a browser installed on the device.

4. The method according to claim 1, wherein, when the device determines more than one electronic map, the method further comprises:
obtaining user request information;
determining an electronic map function according to the user request information; and
determining an electronic map having the determined electronic map function from the more than one electronic map, based on respective functions of the more than one electronic map.

5. The method according to claim 1, wherein when the device determines more than one electronic map matching the electronic map filtrating information, the method further comprises:
displaying respective marks of the more than one electronic map;
receiving a selection of one of the marks; and
loading and displaying an electronic map corresponding to the selected one of the marks.

6. The method according to claim 1, further comprising:
loading and displaying the electronic map determined matching the electronic map filtrating information.

7. A device for providing an electronic map, comprising:
a processor; and
a memory for storing instructions executable by the processor;
wherein the processor is configured to:
receive user input to start an electronic map;
obtain, responsive to the receiving, electronic map filtrating information; and
determine, from a plurality of electronic maps, an electronic map matching the electronic map filtrating information.

8. The device according to claim 7, wherein the electronic map filtrating information is current geographic location information of the device, the processor being further configured to:
determine whether the current geographic location information is identical to pre-stored geographic location information;
if it is determined that the current geographic location information is different from the pre-stored geographic location information, determine an electronic map corresponding to the current geographic location information, according to a preset corresponding relationship between geographic location information and the plurality of electronic maps; and
if it is determined that the current geographic location information is identical to the pre-stored geographic location information, determine an electronic map that was previously determined with respect to the pre-stored geographic location information as the electronic map matching the current geographic location information.

9. The device according to claim 7, wherein the processor is configured to perform at least one of:
obtaining geographic location information of the device based on an IP address;
obtaining the geographic location information based on global positioning system (GPS) positioning;
obtaining the geographic location information based on general packet radio service (GPRS) positioning; or
obtaining the geographic location information through a geographic location application program interface embedded in a browser installed on the device.

10. The device according to claim 7, wherein, when the device determines more than one electronic map, the processor is configured to:
obtain user request information;
determine an electronic map function according to the user request information; and
determine an electronic map having the determined electronic map function from the more than one electronic map, based on respective functions of the more than one electronic map.

11. The device according to claim 7, wherein when the device determines more than one electronic map matching the electronic map filtrating information, the processor is further configured to:
display respective marks of the more than one electronic map;
receive a selection of one of the marks; and
load and display an electronic map corresponding to the selected one of the marks.

12. The device according to claim 7, wherein the processor is further configured to:
load and display the electronic map determined matching the electronic map filtrating information.

13. A non-transitory computer-readable medium having stored therein instructions that, when executed by a processor of a device, cause the device to perform a method for providing an electronic map, the method comprising:
receiving user input to start an electronic map;
obtaining, responsive to the receiving, electronic map filtrating information; and
determining, from a plurality of electronic maps, an electronic map matching the electronic map filtrating information.

14. The non-transitory computer-readable medium according to claim 13, wherein the electronic map filtrating information is current geographic location information of the device, the determining comprising:
determining whether the current geographic location information is identical to pre-stored geographic location information;
if it is determined that the current geographic location information is different from the pre-stored geographic location information, determining an electronic map corresponding to the current geographic location information, according to a preset corresponding relationship between geographic location information and the plurality of electronic maps; and
if it is determined that the current geographic location information is identical to the pre-stored geographic location information, determining an electronic map that was previously determined with respect to the pre-stored geographic location information as the electronic map matching the current geographic location information.

15. The non-transitory computer-readable medium according to claim 13, wherein the obtaining comprises at least one of:
obtaining geographic location information of the device based on an IP address;
obtaining the geographic location information based on global positioning system (GPS) positioning;
obtaining the geographic location information based on general packet radio service (GPRS) positioning; or
obtaining the geographic location information through a geographic location application program interface embedded in a browser installed on the device.

16. The non-transitory computer-readable medium according to claim 13, wherein, when the device determines more than one electronic map, the method further comprises:
obtaining user request information;
determining an electronic map function according to the user request information; and
determining an electronic map having the determined electronic map function from the more than one electronic map, based on respective functions of the more than one electronic map.

17. The non-transitory computer-readable medium according to claim 13, wherein when the device determines more than one electronic map matching the electronic map filtrating information, the method further comprises:
displaying respective marks of the more than one electronic map;
receiving a selection of one of the marks; and
loading and displaying an electronic map corresponding to the selected one of the marks.

18. The non-transitory computer-readable medium according to claim 13, wherein the method further comprises:
loading and displaying the electronic map determined matching the electronic map filtrating information.
